(19) United States
(12) Patent Application Publication
(10) Pub. No.: US 2013/0190971 A1
(43) Pub. Date: Jul. 25, 2013

(54) MULTIFUNCTION LIGHT TRANSCEIVER DEVICE

(71) Applicant: Noel Wayne Anderson, Fargo, ND (US)

(72) Inventor: Noel Wayne Anderson, Fargo, ND (US)

(21) Appl. No.: 13/353,509

(22) Filed: Jan. 19, 2012

(51) Int. Cl. G06F 7/00; G01J 1/42; G01N 21/55; G01C 3/08; G01P 3/36; G01B 11/14; H01J 40/14; G01T 1/20

(52) U.S. Cl. 701/36; 250/221; 250/372; 250/361 R; 356/4.01; 356/28; 356/614; 356/5.01; 356/5.09; 356/4.07; 356/445

(57) ABSTRACT

An exemplary multifunction light transceiver device includes a plurality of light sources. At least one luminescent member is configured to emit visible light responsive to radiation incident on the luminescent member. A controller selectively controls the light sources to achieve multiple functions. The controller controls at least one of the light sources to irradiate the luminescent member to illuminate an area near the device. The controller controls at least one of the light sources to communicate information from the device. The controller also controls at least one of the light sources to emit light toward an object. A detector associated with the controller detects any portion of light that is reflected toward the detector. The controller uses any detected light for making a determination regarding an object from which the detected light reflected.

### BACKGROUND

With improvements in electronics, it has been possible to include more features on vehicles. For example, autonomous and semi-autonomous vehicles may be provided with communication equipment that allows for information to be transmitted from the vehicle to other devices. GPS communications are one example. Other devices allow for communications with roadside devices for a variety of purposes.

A variety of object detection devices have also been developed to assist drivers for avoiding an object behind a vehicle and to assist in parking maneuvers, for example.

Various technologies have been suggested for such devices. One difficulty associated with known arrangements is that they typically involve multiple, bulky and expensive components. These drawbacks can be associated with optical devices and electromagnetic devices.

### SUMMARY

An exemplary multifunction light transceiver device includes a plurality of light sources. At least one luminescent member is configured to emit visible light responsive to radiation incident on the luminescent member. The luminescent member is positioned in a path of light from at least one light source. A controller selectively controls the light sources to achieve multiple functions. The controller controls at least one of the light sources to emit first light to irradiate the luminescent member to illuminate an area near the device. The controller controls at least one of the light sources to emit second light that communicates information from the device. The controller also controls at least one of the light sources to emit third light from the device toward an object in a path of the third light. A detector associated with the controller detects any portion of the third light that is reflected toward the detector. The controller uses any detected third light for making a determination regarding an object from which the detected third light reflected.

An exemplary method of using light includes emitting first light from at least one light source to irradiate at least one luminescent member to illuminate an area. Second light is emitted from at least one light source. The second light communicates information. Third light is emitted from at least one light source toward any object in a path of the third light. The method includes detecting any portion of the third light that is reflected from the object. The detected third light is used for making a determination regarding an object from which the detected third light reflected.

An exemplary vehicle includes a body. A multifunction light transceiver device is supported on the body. The multifunction light transceiver device includes a plurality of light sources. At least one luminescent member is configured to emit visible light responsive to radiation incident on the luminescent member. The luminescent member is positioned in a path of light from at least one of the light sources. A controller selectively controls the light sources. The controller controls at least one of the light sources to emit first light to irradiate the luminescent member to illuminate an area near the vehicle. The controller controls at least one of the light sources to emit second light that communicates information from the vehicle. The controller controls at least one of the light sources to emit third light from the device toward an object in a path of the vehicle. A detector is associated with the controller. The detector detects any portion of the third light that is reflected toward the detector from an object in the path of the vehicle. The controller uses the detected third light for making a determination regarding an object from which the detected third light reflected.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle including a light transceiver device designed according to an embodiment of this invention.

FIG. 2 schematically illustrates selected portions of an example multifunction light transceiver device designed according to an embodiment of this invention.

### DETAILED DESCRIPTION

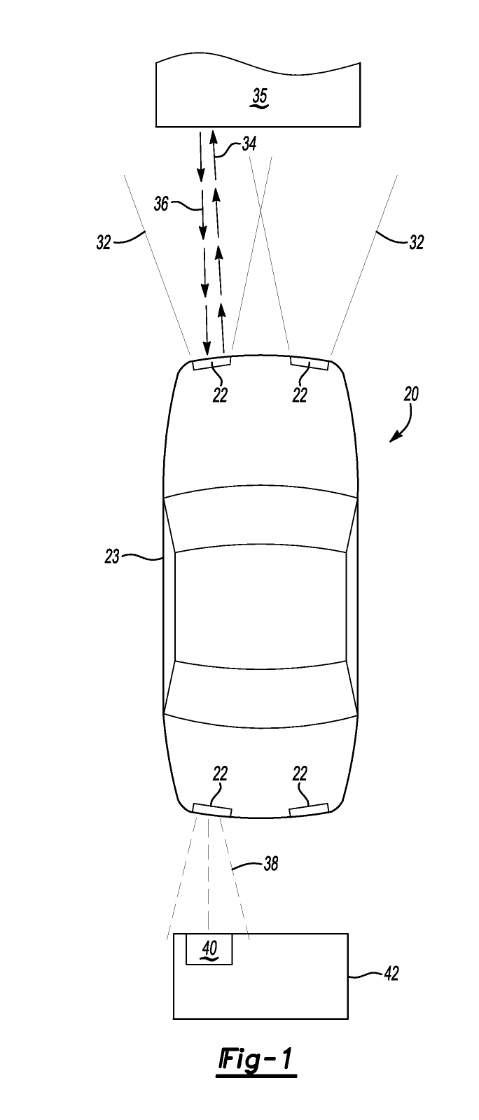

FIG. 1 schematically shows a vehicle 20 that includes a plurality of multifunction light transceiver devices 22 supported in various positions on a body 23 of the vehicle 20.

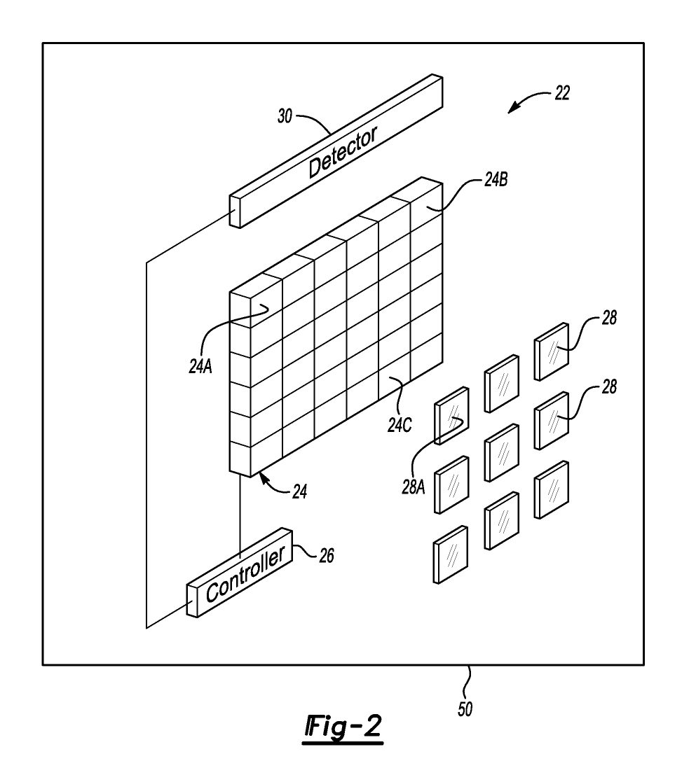

FIG. 2 schematically shows selected elements of an example multifunction light transceiver device 22. A plurality of light sources 24 generate light. A controller 26 selectively controls the plurality of light sources 24. The controller 26 in this example controls the light sources 24 on an individual light source basis. For example, the controller 26 selectively controls different ones of the light sources at different times for different purposes. The various light sources 24 may all emit radiation within a selected portion of the light spectrum in some examples. In other examples, some of the light sources emit one type of radiation while others emit another type of radiation.

In the illustrated example, the multifunction light transceiver device 22 is used for illuminating an area near the device such as an area outside of the vehicle 20. The example device includes at least one luminescent member 28 that is configured to emit visible light responsive to radiation incident on the luminescent member 28. The illustrated example includes a plurality of discrete luminescent members 28. Each luminescent member 28 in this example is positioned in a path of light from a selected one of the light sources 24. For example, the light source 24a emits radiation such as ultraviolet light that is incident on a luminescent member 28a for producing visible light.

One example embodiment of a luminescent member 28 comprises a phosphor member. One example luminescent member 28 comprises a film including phosphor. Other luminescent materials such as fluorescent materials are included in some examples.

The light emitted from the luminescent members 28 may be used for assisting a driver of a vehicle when the multifunction light transceiver device 22 is incorporated into a headlight of the vehicle, for example. The light emitted by the luminescent members 28 may also be used for assisting an automated vehicle to provide illumination within a field of vision of a camera or sensor, for example. Given this description, those skilled in the art will realize how to incorporate the illumination feature of the example multifunction light transceiver device 22 onto a vehicle to meet their particular needs.

In the illustrated example, at least the light source 24a is dedicated exclusively to generating light that is used for irradiating a luminescent member 28 to provide visible light. In other words, at least the light source 24a is exclusively dedicated to generating visible light for an illumination function. Others of the light sources in this example are exclusively dedicated to other functions.

For example, a second one of the light sources 24b generates light for purposes of communicating information from the device 22. There are known techniques of incorporating information and signaling into light transmissions. The controller 26 controls at least the second light source 24b for purposes of communicating information from the device 22 to another device.

At least a third one of the light sources 24c is exclusively dedicated to an environment monitoring function. The light source 24c emits light that radiates toward an object near the device 22. At least some of that light reflects off of the object. Any of the reflected light that is detected by a detector 30 is useful for making a determination regarding the object from which the light reflected. In this example, the controller 26 is programed to make a determination regarding an object from which light reflected and was incident on the detector 30. In one example, the controller 26 makes a determination regarding an approximate distance between the third light source 24b and the object. In another example, the controller 26 makes a determination regarding a speed at which the third light source 24c is approaching the object from which the light reflected. In another example, the controller 26 determines an approximate position of the object relative to the third light source. In another example, the controller 26 determines a combination of at least two of the approximate distance, speed and position mentioned above.

In one example, the controller 26 is programmed to use time of flight analysis techniques for making the selected determination regarding the object from which light reflected. In another example, the controller 26 is programed to use a phase shift of the reflected light for purposes of making the intended determination. In another example, the controller 26 uses an intensity of the detected light for purposes of making the determination regarding the object from which the light reflected. In still another example, the controller 26 uses more than one of the mentioned techniques depending on the determination being made at a particular time. Given this description, those skilled in the art will be able to select from among known techniques for using reflected light for making such determinations regarding an object that is detected using light from the multifunction light transceiver 22.

The detector 30 is useful for detecting light emitted from another device so that the device 22 may receive information from another device that emits light toward the device 22. The controller 26 in this example is configured to interpret such information and use it according to the needs of a given situation.

In one example, the controller 26 utilizes information regarding a detected object where information communicated from another device for purposes of controlling the functionality or operation of one or more of the light sources 24. For example, if the controller 26 determines that there is an object in a pathway of a vehicle, some of the light sources that are used for communication purposes may be operated to attempt to communicate with a transceiver associated with that object. Alternatively, the light sources used for illumination may be turned on to illuminate an area where the object is expected to be. In another example, the controller 26 increases the intensity or brightness of light to provide an enhanced ability to observe the object.

In another example, the controller 26 is part of a controller of the vehicle 20 shown in FIG. 1. In such an example, the controller 26 responds to information available from light gathered by the detector 30 for purposes of controlling a function of the vehicle 20. For example, when an object is detected in front of a moving vehicle that is currently being driven using a cruise control function, the controller 26 may automatically reduce the speed of the vehicle to maintain a desired distance between the vehicle and the object that is detected in front of the vehicle. For automated or semi-automated vehicles, the controller 26 may utilize information regarding light gathered by the detector 30 for purposes of steering the vehicle to avoid an object or stopping the vehicle, for example. Given this description, those skilled in the art will realized how a controller 26 configured for their particular application will be able to perform such functions to meet their particular needs.

FIG. 1 schematically shows an illumination function of the multifunction light transceiver devices 22. Visible light is schematically shown at 32 for illuminating an area near the vehicle 20. Environment monitoring light is schematically shown at 34 emitted by at least one of the light sources of at least one of the multifunction light transceiver devices 22. In FIG. 1, at least some of the light reflects off an object 35 as schematically shown at 36. Such reflected light may be used for the purposes described above. Communication of information is schematically shown at 38. In this example, at least one of the multifunction light transceiver devices 22 includes at least one light source for emitting light that contains information that is useful to another transceiver device 40 that is associated with a structure 42. The structure 42 may be an object such as a toll both or other monitoring station along a road, a building or another vehicle. Given this description, those skilled in the art will realize the various types of communication that will be useful using a multifunction light transceiver device designed according to an embodiment of this invention that will meet their particular needs.

In one example, the light sources 24 each comprise a laser diode. The laser diodes may emit the same wavelength of light or different laser diodes may emit different wavelengths. Another example includes light emitting diodes as the light sources 24. Still another example includes a combination of laser diodes and light emitting diodes. One feature of either type of light source is that it is compact in size and allows for the entire multifunction light transceiver device 22 to be maintained within a single housing 50. This avoids the bulky or distributed features associated with previous attempts at providing the types of functions that are available with the example multifunction light transceiver 22. The ability to place all of the components of the device 22 within a single housing 50 allows for a relatively compact device that provides space savings and decreases the possible uses for the device. The relatively low cost and compact features of the disclosed example provide an economical arrangement for achieving a variety of features or functions from a single device. Integrating illumination, communication and environmental monitoring into a single device using the example multi-function light transceiver devices 22 reduces material and labor costs associated with attempting to provide components to achieve the various functions on a single vehicle, for example.

In some examples, the vehicle 20 comprises a passenger vehicle. In other examples, the vehicle 20 comprises a heavy vehicle such as a truck. In still other examples, the vehicle 20 comprises off road machinery such as farming equipment or construction equipment. Depending on the type of vehicle, the multifunction light transceiver devices 22 will be configured to achieve the particular features desired for that vehicle.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A multifunction light transceiver device, comprising:
a plurality of light sources;
at least one luminescent member configured to emit visible light responsive to radiation incident on the luminescent member, the luminescent member being positioned in a path of light from at least one of the light sources;
a controller associated with the light sources, the controller being configured to selectively control the light sources including
controlling at least one of the light sources to emit first light to irradiate the luminescent member to illuminate an area near the device,
controlling at least one the light sources to emit second light that communicates information from the device, and
controlling at least one of the light sources to emit third light from the device toward any object in a path of the third light; and
a detector associated with the controller, the detector detecting any portion of the third light that is reflected toward the detector, the controller using any detected third light for making a determination regarding an object from which the detected third light reflected.

2. The device of claim 1, wherein the plurality of light sources comprises a plurality of laser diodes.

3. The device of claim 1, wherein the first light comprises ultraviolet light.

4. The device of claim 3, wherein the second and third light are different than ultraviolet light.

5. The device of claim 3, wherein the luminescent member comprises phosphor and emits white light responsive to the ultraviolet light.

6. The device of claim 1, wherein the determination regarding the object comprises at least one of
(i) an approximate distance between the device and the object,
(ii) a speed at which the device is approaching the object, and
(iii) an approximate position of the object relative to the device.

7. The device of claim 6, wherein the controller uses at least one of
(i) a time of flight,
(ii) a phase shift, and
(iii) an intensity of the detected third light.

8. The device of claim 1, wherein the controller adaptively controls at least one of the light sources responsive to the determination regarding the object.

9. The device of claim 1, wherein
some of the plurality of light sources are dedicated to generating the first light for illuminating the area near the device;
some of the plurality of light sources are dedicated to generating the second light for communicating information from the device; and
some of the plurality of light sources are dedicated to generating the third light.

10. A method of using light, comprising the steps of:
emitting first light from at least one light source to irradiate at least one luminescent member to illuminate an area;
emitting second light from at least one light source, the second light communicating information;
emitting third light from at least one light source toward any object in a path of the third light;
detecting any portion of the third light that is reflected from the object; and
using a controller for making a determination regarding an object from which the detected third light reflected.

11. The method of claim 10, wherein the light sources each comprise a laser diode.

12. The method of claim 10, comprising emitting ultraviolet light as the first light; and
emitting white light from the luminescent member responsive to the ultraviolet light.

13. The method of claim 10, comprising making the determination regarding the object by determining at least one of
(i) an approximate distance between a source of the third light and the object,
(ii) a speed at which the source of the third light is approaching the object, and
(iii) an approximate position of the object relative to the source of the third light.

14. The method of claim 13, comprising using at least one of
(i) a time of flight,
(ii) a phase shift, and
(iii) an intensity
of the detected third light for making the determination.

15. The method of claim 10, comprising adaptively controlling at least one of the light sources responsive to the determination regarding the object.

16. A vehicle, comprising:
a body; and
a multifunction light transceiver device supported on the body, the multifunction light transceiver device, comprising
a plurality of light sources;
at least one luminescent member configured to emit visible light responsive to radiation incident on the luminescent member, the luminescent member being positioned in a path of light from at least one of the light sources;
a controller associated with the light sources, the controller being configured to selectively control the light sources including
controlling at least one of the light sources to emit first light to irradiate the luminescent member to illuminate an area near the vehicle,
controlling at least one of the light sources to emit second light that communicates information from the vehicle, and
controlling at least one of the light sources to emit third light from the device toward any object in a path of the vehicle; and
a detector associated with the controller, the detector detecting any portion of the third light that is reflected toward the detector, the controller using any detected third light for making a determination regarding an object from which the detected third light reflected.

17. The vehicle of claim 16, wherein the plurality of light sources comprises a plurality of laser diodes.

18. The vehicle of claim 16, wherein the first light comprises ultraviolet light; and
the luminescent member comprises phosphor and emits white light responsive to the ultraviolet light.

19. The vehicle of claim 16, wherein the controller uses at least one of
(i) a time of flight,
(ii) a phase shift, and
(iii) an intensity
of the detected third light for making the determination; and
the determination regarding the object comprises at least one of
(i) an approximate distance between the vehicle and the object,
(ii) a speed at which the vehicle is approaching the object, and
(iii) an approximate position of the object relative to the vehicle.

20. The vehicle of claim 16, wherein the controller
adaptively controls at least one of the light sources responsive to the determination regarding the object; or
adaptively controls at least one vehicle function responsive to the determination regarding the object.
